(19) United States
(12) Patent Application Publication
(10) Pub. No.: US 2018/0361590 A1
(43) Pub. Date: Dec. 20, 2018

(54) ACTIVE ASSEMBLY SYSTEM, ACTIVE ASSEMBLY METHOD AND POSITIONING ASSEMBLY DEVICE THEREOF

(71) Applicant: Chung-Yuan Christian University, Tao Yuan County (TW)

(72) Inventors: YUNG TING, Tao Yuan County (TW); JUN-RONG WANG, Tao Yuan County (TW)

(21) Appl. No.: 15/997,027

(22) Filed: Jun. 4, 2018

(30) Foreign Application Priority Data
Jun. 16, 2017 (TW) 106120266

(51) Int. Cl. B25J 9/16; B25J 19/04; B23P 19/10

(52) U.S. Cl. CPC B25J 9/1697; G06T 7/11; B23P 19/10; B25J 19/04

(57) ABSTRACT

An active assembly system, an active assembly method and a positioning assembly device thereof are disclosed. The active assembly system, used for assembling a first assembly and a second assembly together, includes a main control device and the positioning assembly device. The positioning assembly device includes a fixed bracket, a drive device, and a robotic arm. The fixed bracket is used for setting the first assembly. The drive device has the capability of performing multiple degrees of freedom of motion. The robotic arm, used for setting the second assembly, is fixedly linked to the drive device and is actuated simultaneously with the drive device, wherein when the first assembly and the second assembly are assembled together, the main control device drives the drive device and the robotic arm according to the assembly image to adjust an assembly position and an assembly angle of the second assembly.

### BACKGROUND OF THE INVENTION

### 1. Field of the Invention

The present invention relates to an active assembly system, an active assembly method, and a positioning assembly device thereof, and more particularly, to an active assembly system, an active assembly method, and a positioning assembly device thereof capable of adjusting an assembly position and an assembly angle precisely.

### 2. Description of the Related Art

With the advancement of technologies, mobile devices with photographic capabilities such as mobile phones or tablet computers are increasingly popular. However, mobile phones or tablet computers with an optical lens need to go through a critical bonding process. The lens needs to be aligned in the correct position before it is joined to a bonding component of a mobile phone or a tablet computer. Thus, the prior art assembling process often uses an active alignment system such as ProCam® Align Smart, which is a system developed by TRIOPTICS. The system uses a traditional rotary motor to transmit power through a lead screw mechanism. Because of this technology, the position adjustment of the alignment is a uniaxial movement and will take a long time. Moreover, the machine itself and the peripheral parts such as ancillary transmission components are complex and ponderous. An enormous actuation system is needed even when transporting light lens components. The machine is bulky and inefficient. In addition, the fixed automation mode is limited in terms of customization and lacks flexibility. During the manufacturing process, if any adjustments or changes are required, no relevant mechanisms and or even the control system can be easily altered. Such adjustments or changes could even result in redesigning the entire manufacturing process. A three-axis parallel-link robotic arm platform named Fanuc Delta has also been disclosed in the prior art. However, the mode of motion of the robotic arm platform is three-dimensional coupling in space, which is a translational movement of a curve. It cannot perform a two-directional rotation simultaneously. It is also not suitable for independent azimuthal movements but needs the superposition of a 3-axis wrist to perform three degrees of freedom of rotational motion in space. As a result, this system does not support operations combining translation and rotation.

Therefore, it is desirable to provide an improved active assembly system and an active assembly method to mitigate and/or obviate the aforementioned problems.

### SUMMARY OF THE INVENTION

It is a main object of the present invention to provide an active assembly system capable of adjusting an assembly position and an assembly angle precisely.

It is another main object of the present invention to provide an active assembly method used in the aforementioned system.

It is the other main object of the present invention to provide a positioning assembly device used in the aforementioned system.

In order to achieve the above-mentioned objects, the active assembly system of the present invention is used for assembling a first assembly and a second assembly together. The active assembly system comprises a main control device and the positioning assembly device. The positioning assembly device comprises a fixed bracket, an image capture module, a drive device, and a robotic arm. The robotic arm has the capability of performing multiple degrees of freedom of motion. The number of degrees of freedom of required motion in space is preferably six. The fixed bracket is used for setting the first assembly. The image capture module is electrically connected to the main control device and set onto the fixed bracket and is used for capturing an assembly image when the first assembly and the second assembly are assembled together. The drive device is electrically connected to the main control device and has the capability of performing multiple degrees of freedom of motion required when the first assembly and the second assembly are assembled together or six degrees of freedom of motion in space. The robotic arm is fixedly linked to the drive device and is actuated simultaneously with the drive device. Moreover, the robotic arm is used for setting the second assembly, wherein when the first assembly and the second assembly are assembled together, the main control device drives the drive device and the robotic arm according to the assembly image to adjust an assembly position and an assembly angle of the second assembly.

The active assembly method of the present invention comprises the following steps: setting a first assembly onto a fixed bracket; setting a second assembly onto a robotic arm, wherein the robotic arm is fixedly linked to a drive device and is actuated simultaneously with the drive device, wherein the drive device has the capability of performing multiple degrees of freedom of motion required when the first assembly and the second assembly are assembled together or six degrees of freedom of motion in space; capturing an assembly image when the first assembly and the second assembly are assembled together; and driving the drive device and the robotic arm in real time according to the assembly image to adjust an assembly position and an assembly angle of the second assembly.

The positioning assembly device of the present invention, used in the active assembly system and electrically connected to a main control device, is used for assembling a first assembly and a second assembly together. The positioning assembly device comprises a fixed bracket, an image capture module, a drive device, and a robotic arm. The fixed bracket is used for setting the first assembly. The image capture module is electrically connected to the main control device and set onto the fixed bracket and is used for capturing an assembly image when the first assembly and the second assembly are assembled together. The drive device is electrically connected to the main control device and has the capability of performing multiple degrees of freedom of motion required when the first assembly and the second assembly are assembled together or six degrees of freedom of motion in space. The robotic arm is fixedly linked to the drive device and is actuated simultaneously with the drive device. Moreover, the robotic arm is used for setting the second assembly, wherein when the first assembly and the second assembly are assembled together, the main control device drives the drive device and the robotic arm according to the assembly image to adjust an assembly position and an assembly angle of the second assembly.

### BRIEF DESCRIPTION OF THE DRAWINGS

FIG. 1 is a schematic drawing showing the constitution of an active assembly system of the present invention;

FIG. 2 is a schematic drawing of the structure of a positioning assembly device of the present invention;

FIG. 3 is a flowchart showing the steps of an active assembly method of the present invention; and

FIG. 4 is a flowchart showing the steps of a method of driving a drive device of the present invention.

### DETAILED DESCRIPTION OF THE PREFERRED EMBODIMENT

The advantages and innovative features of the invention will become more apparent from the following detailed description when taken in conjunction with the accompanying drawings.

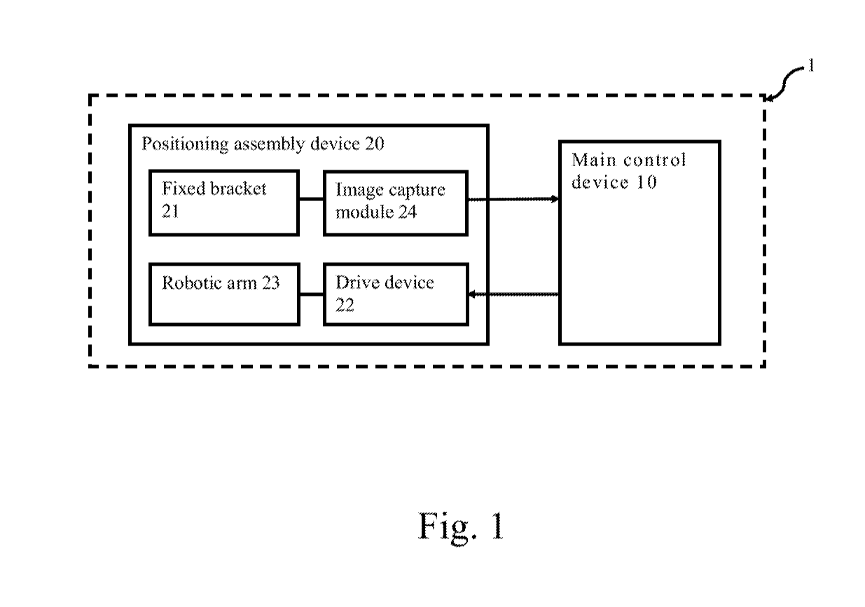

First, for the following description, please refer to FIG. 1. FIG. 1 is a schematic drawing showing the constitution of an active assembly system of the present invention.

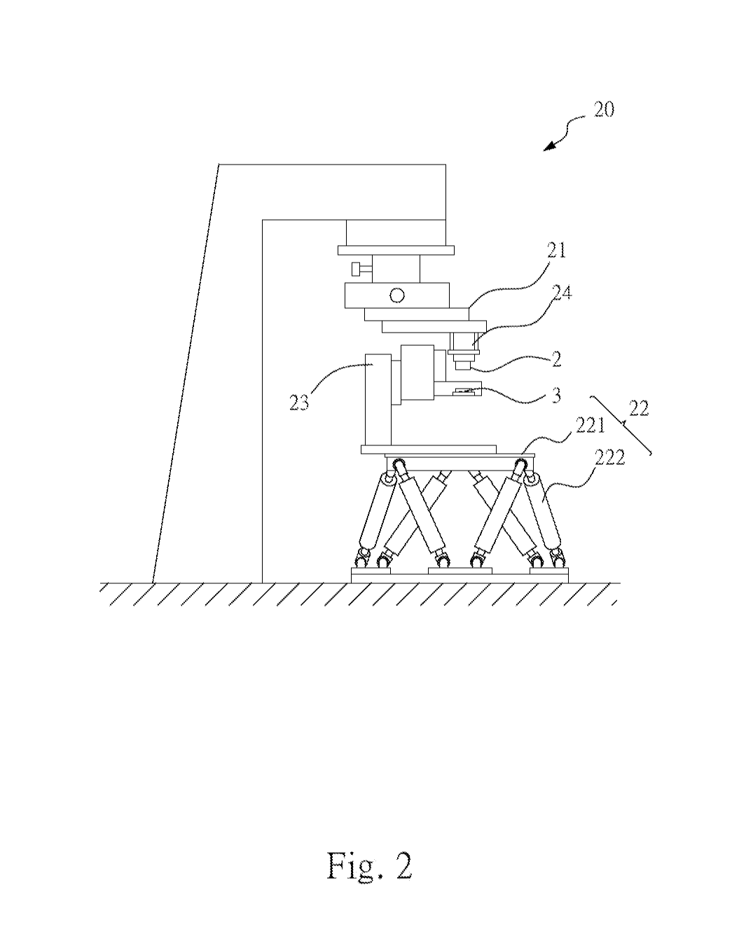

The present invention provides an active assembly system 1 used for assembling a first assembly 2 and a second assembly 3 (as shown in FIG. 2) together. The active assembly system 1 comprises a main control device 10 and a positioning assembly device 20. The main control device 10 can be an industrial PC, a desktop computer, a notebook computer, a tablet computer, etc. The same purpose can be accomplished by using an application program able to be stored in a memory module associated with a general desktop computer, notebook computer, or tablet computer. However, please note that the scope of the present invention is not limited to the above description. In one embodiment of the present invention, the positioning assembly device 20 comprises a fixed bracket 21, a drive device 22, a robotic arm 23, and an image capture module 24, which are controlled by the main control device 10 in order to assemble the first assembly 2 and the second assembly 3 together. In one embodiment of the present invention, the first assembly 2 can be a camera lens. The second assembly 3 can be a bonding component allowing a camera lens to be mounted thereto, but please note that the scope of the present invention is not limited to the above description.

Please refer to FIG. 2. FIG. 2 is a schematic drawing of the structure of a positioning assembly device of the present invention.

In one embodiment of the present invention, the fixed bracket 21 of the positioning assembly device 20 sets the first assembly 2 by clamping or engaging with the first assembly 2. The fixed bracket 21 can be connected to another fixed support, base, or bench, or to the floor; however, the present invention is not limited thereto. Also, the present invention is not limited to the manner in which the first assembly 2 is fixed. The drive device 22, which is electrically connected to the main control device 10, has the capability of performing multiple degrees of freedom of motion required when the first assembly and the second assembly are assembled together or six degrees of freedom of motion in space according to the command of the main control device 10. The number of degrees of freedom of required motion is preferably six. In one embodiment of the present invention, the drive device 22 is a Stewart Platform Base, which comprises a base 221 and six actuators 222 connected to the base 221. The operation theory is described as follows: The actuators 222 (pneumatic, hydraulic, or motor) drive connecting rods and cause length changes of the connecting rods such that the base 221 can be moved (spatially) in the six degrees of freedom: surge, sway, heave, roll, pitch, and yaw. The first three are linear motions. Here, surging is the motion along the longitudinal X-axis of the base 221, swaying is the motion along the lateral Y-axis of the base 221, and heaving is the motion along the vertical Z-axis of the base 221. The last three are rotational motions. Rolling is a rotation around the longitudinal X-axis of the base 221, pitching is a rotation around the lateral Y-axis of the base 221, and yawing is a rotation around the vertical Z-axis of the base 221. Because the effect and the manner of control of a Stewart Platform Base are well known to those of reasonable skill in the art, the detailed description is omitted. The present invention is not limited to a Stewart Platform Base or other individual drive platform. Any device or system which has the capability of performing multiple degrees of freedom of motion required during an assembly process or six degrees of freedom of motion in space is within the scope of the present invention.

The robotic arm 23 sets the second assembly 3 by clamping or engaging with the second assembly 3. However, the present invention is not limited to the manner in which the second assembly 3 is fixed. The robotic arm 23 is fixedly linked to the drive device 22 and is actuated simultaneously with the drive device 22 such that multiple degrees of freedom of motion are performed. The number of degrees of freedom of required motion in space is preferably six. Thus, when the first assembly 2 and the second assembly 3 are assembled together, the main control device 10 drives the drive device 22 to move along the X-axis, Y-axis, or Z-axis or to rotate around the X-axis, Y-axis, or Z-axis. Because the robotic arm 23 is fixedly linked to the drive device 22, the robotic arm 23 is drivingly associated with the drive device 22 and moves simultaneously with the drive device 22 so as to adjust an assembly position and an assembly angle of the second assembly 3. Therefore, the first assembly 2 and the second assembly 3 can be assembled together conveniently.

In one embodiment of the present invention, the positioning assembly device 20 can further comprise the image capture module 24. The image capture module 24 is electrically connected to the main control device 10 and set onto the fixed bracket 21. The image capture module 24 is located above the position in which the first assembly 2 is set. The image capture module 24 can be made of a CMOS or a CCD; however, the present invention is not limited thereto. When the first assembly 2 and the second assembly 3 are assembled together, the image capture module 24 captures an assembly image from right above the first assembly 2 and transfers the assembly image to the main control device 10. The main control device 10 determines whether the first assembly 2 is aligned with the second assembly 3 according to the assembly image. Moreover, the main control device 10 issues an adjustment command to the drive device 22 in real time to adjust the assembly position and the assembly angle of the second assembly 3. After the main control device 10 determines that the first assembly 2 is aligned with the second assembly 3 according to the assembly image, the first assembly 2 and the second assembly 3 are allowed to be assembled together. Thus, the goal of precise assembly is accomplished. Because the manner of control of the main control device 10 is described in detail in the following flowcharts, it is not elaborated here.

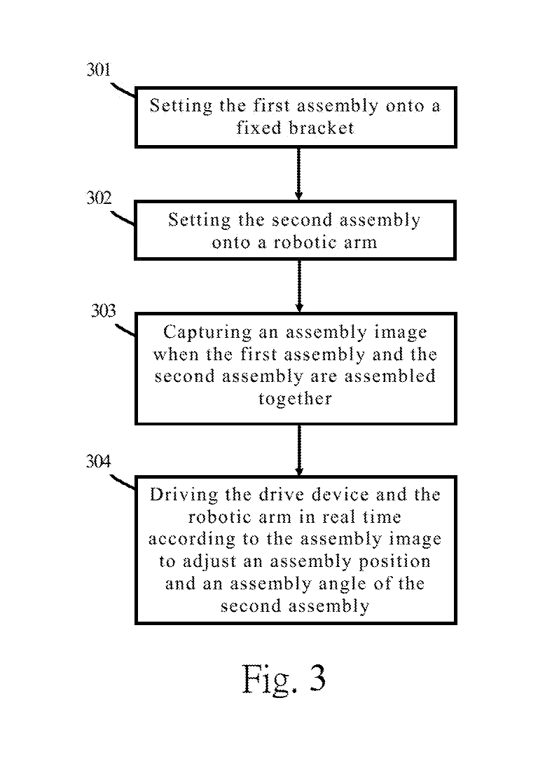

Next, please refer to FIG. 3, which is a flowchart showing the steps of an active assembly method of the present invention. Please note that the active assembly method of the present invention is described in the following paragraphs with the example of the aforementioned positioning assembly device 20 of the active assembly system 1; however, the active assembly method of the present invention is not limited to the use of the aforementioned positioning assembly device 20 or an equivalent structure of a device.

The present invention performs step 301 first: setting the first assembly onto a fixed bracket.

First, a fixed bracket 21 is used for setting the first assembly 2, which is going to be assembled.

Next, the present invention performs step 302: setting the second assembly onto a robotic arm.

Next, a robotic arm 23 is used for setting the second assembly 3, which is going to be assembled. Moreover, the robotic arm 23 is fixedly linked to the drive device 22 and is actuated simultaneously with the drive device 22.

Next, the present invention performs step 303: capturing an assembly image when the first assembly and the second assembly are assembled together.

When the first assembly 2 and the second assembly 3 are assembled together, the image capture module 24 captures an assembly image of the first assembly 2 and the second assembly 3 and transfers the assembly image to the main control device 10.

Last, the present invention performs step 304: driving the drive device and the robotic arm in real time according to the assembly image to adjust an assembly position and an assembly angle of the second assembly.

Last, the main control device 10 controls the six-axis drive device 22 in real time according to the assembly image to adjust the assembly position and the assembly angle of the second assembly 3. After the main control device 10 determines that the first assembly 2 is aligned with the second assembly 3 according to the assembly image, the first assembly 2 and the second assembly 3 are allowed to be assembled together. Thus, the purpose of precise assembly is accomplished.

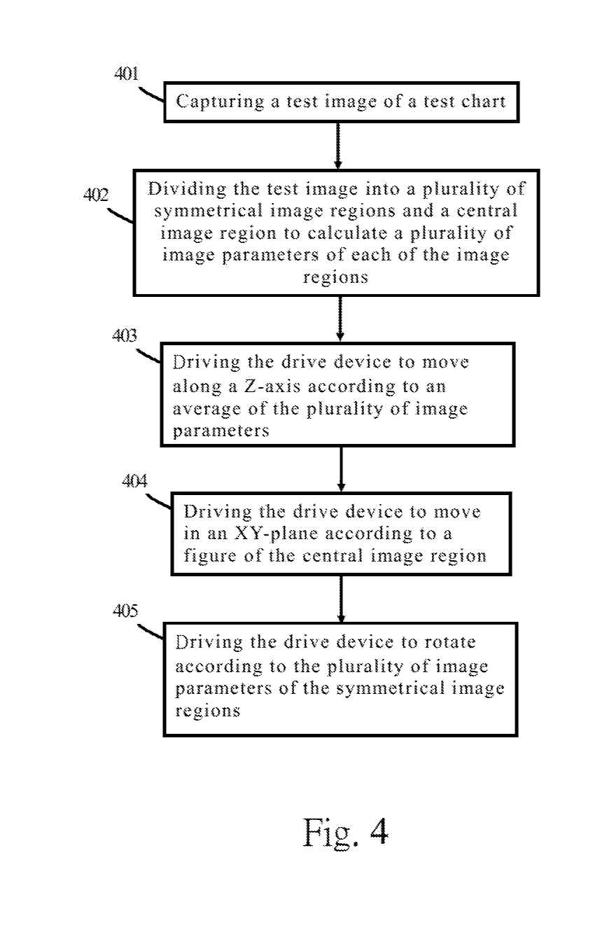

A Spatial Frequency Response (SFR) can be calculated in the step of driving the driving device 22 when the image capture module 24 captures the assembly image, as shown in FIG. 4. FIG. 4 is a flowchart showing the steps of a method of driving a drive device of the present invention.

First, the present invention performs step 401: capturing a test image of a test chart.

First, the image capture module 24 is used to capture a test image of a test chart. The test chart is placed in the same position as the second assembly 3. In one embodiment of the present invention, the test chart is an ISO12233 resolution test chart. However, please note that the scope of the present invention is not limited to the above description.

Next, the present invention performs step 402: dividing the test image into a plurality of symmetrical image regions and a central image region to calculate a plurality of image parameters of each of the image regions.

Next, after the image capture module 24 captures the test image of the test chart, the main control device 10 can obtain the test image and find a plurality of image regions from the test image. For example, the main control device 10 can divide the test image into a plurality of symmetrical image regions and a central image region. The plurality of symmetrical image regions may include the upper and lower image regions in the middle of the test image and the image regions in the four corners. However, the present invention is not limited to the number of the image regions. There is a principle that the selection of images should be symmetrical. (The principle of selection of the image regions is to select pairs. Each one of the pair has to be symmetrical to the other one of the same pair.) Take the ISO12233 resolution test chart for example, wherein the ISO12233 resolution test chart is a prior art resolution test chart. The main control device 10 can recognize the positions of each of the regions symmetrical to each other on the test chart and can synchronously calculate a plurality of image parameters of each of the image regions. In this embodiment, the image parameter may be MTF (Modulation Transfer Function) 50; however, the present invention is not limited thereto.

Next, the present invention performs step 403: driving the drive device to move along a Z-axis according to an average of the plurality of image parameters.

Next, the main control device 10 can calculate an average of the plurality of image parameters to drive the drive device 22 to move along a Z-axis according to the average. In this embodiment, the image parameter can be MTF50. The larger the value of the MTF50, the better the clarity of the captured test image. Therefore, the main control device 10 drives the drive device 22 to move to a position on the Z-axis in which the value of the average of the plurality of image parameters is the largest.

Next, the present invention performs step 404: driving the drive device to move in an XY-plane according to a figure of the central image region.

Next, the main control device 10 controls the drive device 22 to move in an XY-plane so that the central image region can be moved to the very center of the test image.

Last, the present invention performs step 405: driving the drive device to rotate according to the plurality of image parameters of the symmetrical image regions.

Last, the main control device 10 may divide the test image into four areas: upper, lower, left, and right areas. They are referred to as the four quadrants. Next, the main control device 10 compares the plurality of image parameters of the symmetrical image regions in each quadrant and finds the average of the image parameters (i.e., the average of MTF50). The main control device 10 then finds the quadrant where the value of the average of the image parameters (i.e., the average of MTF50) is the smallest so that the X-axis and the Y-axis of the drive device 22 can rotate along the quadrant and its diagonal quadrant. The main control device 10 then compares the difference between averages of MTF50 of the upper and lower areas and the difference between averages of MTF50 of the left and right areas after the individual rotation. Next, the main control device 10 finds a quadrant where the value of the difference between averages is smaller, and the quadrant is the direction of rotation of the adjustment. The main control device 10 can continuously make adjustments until the difference between averages of the image parameters of all the four areas (upper, lower, left, and right areas) is equal to or less than a specific value.

Last, the main control device 10 controls the drive device 22 to rotate around the Z-axis until the main control device 10 confirms that the difference between averages of the plurality of image parameters of the image regions in the four corners is equal to or less than the specific value. Thus it can be seen that the rotation of the drive device 22 is a continuous process of control. The main control device 10 drives the drive device 22 to rotate synchronously around two axes first and then drives the drive device 22 to rotate around the remaining axis. By doing it this way, the adjustments of the drive device 22 can be completed to achieve the optimum assembly position and assembly angle.

It is noted that the active assembly method of the present invention is not limited to the order of the steps mentioned above. As long as the object of the present invention is achieved, the order of the steps mentioned above can be varied. The drive process of the drive device 22 is merely an example. The scope of the present invention is not limited to the above description.

It is noted that the above-mentioned embodiments are only for illustration. It is intended that the present invention cover modifications and variations of this invention provided they fall within the scope of the following claims and their equivalents. Therefore, it will be apparent to those skilled in the art that various modifications and variations can be made to the structure of the present invention without departing from the scope or spirit of the invention.

What is claimed is:

1. An active assembly system, used for assembling a first assembly and a second assembly together, comprising:
a main control device; and
a positioning assembly device, comprising:
a fixed bracket used for setting the first assembly;
an image capture module electrically connected to the main control device and set onto the fixed bracket, the image capture module being used for capturing a test image of a test chart and an assembly image when the first assembly and the second assembly are assembled together;
a drive device electrically connected to the main control device, the drive device having the capability of performing multiple degrees of freedom of motion required when the first assembly and the second assembly are assembled together or six degrees of freedom of motion in space; and
a robotic arm fixedly linked to the drive device and actuated simultaneously with the drive device, the robotic arm being used for setting the second assembly, wherein the main control device divides the test image into a plurality of symmetrical image regions and a central image region to calculate a plurality of image parameters of each of the image regions, thus when the first assembly and the second assembly are assembled together, the main control device drives the drive device and the robotic arm according to the plurality of image parameters and the assembly image to adjust an assembly position and an assembly angle of the second assembly.

2. The active assembly system as claimed in claim 1, wherein the main control device drives the drive device to move along a Z-axis according to an average of the plurality of image parameters, drives the drive device to move in an XY-plane according to a figure of the central image region, and drives the drive device to rotate according to a difference between averages of the plurality of image parameters of the symmetrical image regions, thus the assembly position and the assembly angle of the second assembly can be adjusted.

3. The active assembly system as claimed in claim 2, wherein the main control device drives the drive device to rotate synchronously around two axes and drives the drive device to rotate around the remaining axis.

4. The active assembly system as claimed in claim 1, wherein the image capture module is a CMOS.

5. An active assembly method, used for assembling a first assembly and a second assembly together, comprising the following steps:
setting the first assembly onto a fixed bracket;
setting the second assembly onto a robotic arm, wherein the robotic arm is fixedly linked to a drive device and is actuated simultaneously with the drive device, wherein the drive device has the capability of performing multiple degrees of freedom of motion required when the first assembly and the second assembly are assembled together or six degrees of freedom of motion in space;
capturing an assembly image when the first assembly and the second assembly are assembled together; and
driving the drive device and the robotic arm in real time according to the assembly image to adjust an assembly position and an assembly angle of the second assembly, wherein the step of driving the drive device according to the assembly image further comprises:
capturing a test image of a test chart;
dividing the test image into a plurality of symmetrical image regions and a central image region to calculate a plurality of image parameters of each of the image regions;
driving the drive device to move along a Z-axis according to an average of the plurality of image parameters;
driving the drive device to move in an XY-plane according to a figure of the central image region; and
driving the drive device to rotate according to a difference between averages of the plurality of image parameters of the symmetrical image regions.

6. The active assembly method as claimed in claim 5 further comprising the following step:
capturing the assembly image with a CMOS.

7. The active assembly method as claimed in claim 5, wherein the step of driving the drive device to rotate comprises:
driving the drive device to rotate synchronously around two axes; and
driving the drive device to rotate around the remaining axis.

8. A positioning assembly device, used in an active assembly system and electrically connected to a main control device, for assembling a first assembly and a second assembly together, the positioning assembly device comprising:
a fixed bracket used for setting the first assembly;
an image capture module electrically connected to the main control device and set onto the fixed bracket, the image capture module being used for capturing a test image of a test chart and an assembly image when the first assembly and the second assembly are assembled together;
a drive device electrically connected to the main control device, the drive device having the capability of performing multiple degrees of freedom of motion required when the first assembly and the second assembly are assembled together or six degrees of freedom of motion in space; and
a robotic arm fixedly linked to the drive device and actuated simultaneously with the drive device, the robotic arm being used for setting the second assembly, wherein the main control device divides the test image into a plurality of symmetrical image regions and a central image region to calculate a plurality of image parameters of each of the image regions, thus when the first assembly and the second assembly are assembled together, the main control device drives the drive device and the robotic arm according to the plurality of image parameters and the assembly image to adjust an assembly position and an assembly angle of the second assembly.

9. The positioning assembly device as claimed in claim 8, wherein the main control device drives the drive device to move along a Z-axis according to an average of the plurality of image parameters, drives the drive device to move in an XY-plane according to a figure of the central image region, and drives the drive device to rotate according to a difference between averages of the plurality of image parameters of the symmetrical image regions, thus the assembly position and the assembly angle of the second assembly can be adjusted.

10. The positioning assembly device as claimed in claim 9, wherein the main control device drives the drive device to rotate synchronously around two axes and drives the drive device to rotate around the remaining axis.

11. The positioning assembly device as claimed in claim 8, wherein the image capture module is a CMOS.
